(19) United States
(12) Patent Application Publication
(10) Pub. No.: US 2026/0140392 A1
(43) Pub. Date: May 21, 2026

(54) EYEWEAR STEMS FOR EYEWEAR

(71) Applicant: Oakley, Inc., Foothill Ranch, CA (US)

(72) Inventors: Matt COPPLER, Mission Viejo, CA (US); Casey Corrigan LEE, Orange, CA (US)

(21) Appl. No.: 19/382,722

(22) Filed: Nov. 7, 2025

Related U.S. Application Data
(60) Provisional application No. 63/718,138, filed on Nov. 8, 2024.

(51) Int. Cl. G02C 5/14; G02C 5/16

(52) U.S. Cl. CPC G02C 5/143; G02C 5/16

(57) ABSTRACT

Embodiments comprise an eyewear. The eyewear comprises an car stem. A product of an average pressure and a displacement is less than or equal to about 25 N/mm when a headform is subjected to an acceleration of 17 g and the average pressure is measured by at least one pressure sensitive area on the headform.

### CROSS REFERENCE TO RELATED PATENT APPLICATION

This application claims the benefit of U.S. Provisional Patent Application No. 63/718,138, entitled “EYEWEAR STEMS FOR EYEWEAR,” filed on Nov. 8, 2024. The entire content of the above referenced application is incorporated by reference herein in its entirety.

### BACKGROUND

Eyewear may be used during sporting activities to protect the eyes of a wearer against environmental conditions such as harsh light. Bands encircling a wearer's head have often been used for retention in high movement sporting activities. However, such a band can be uncomfortable for the wearer when worn for a prolonged time, and may be difficult to take on and off.

### BRIEF DESCRIPTION OF THE DRAWINGS

Aspects of this disclosure are best understood from the following detailed description when read with the accompanying figures. It is noted that, in accordance with the common practice in the industry, various features are not drawn to scale. In fact, the dimensions of the various features may be arbitrarily increased or reduced for clarity of discussion, except where noted otherwise.

FIG. 1A is a schematic that illustrates a perspective view of an eyewear configured to provide head retention and pressure performance enhancement, according to some aspects.

FIG. 1B is a schematic that illustrates a side view of an eyewear configured to provide head retention and pressure performance enhancement, according to some aspects.

FIG. 2A is a schematic that illustrates a perspective view of an eyewear configured to provide head retention and pressure performance enhancement, according to some aspects.

FIG. 2B is a schematic that illustrates a side view of an eyewear configured to provide head retention and pressure performance enhancement, according to some aspects.

FIG. 3 is a schematic that illustrates an ear stem configured to provide head retention and pressure performance enhancement, according to some aspects.

FIG. 4 is a schematic that illustrates an ear stem with pressure and retention adjustment, according to some aspects.

FIG. 5 is a schematic that illustrates a pressure measurement environment, according to some aspects.

FIG. 6 is a schematic that illustrates a displacement measurement environment, according to some aspects.

FIG. 7 is a schematic that illustrates a perspective view of disassembled components of an eyewear configured to provide head retention and pressure performance enhancement, according to some aspects.

Illustrative embodiments will now be described with reference to the accompanying drawings. In the drawings, like reference numerals generally indicate identical, functionally similar, and/or structurally similar elements.

### DETAILED DESCRIPTION

The following disclosure provides many different aspects (also referred to herein as embodiments or examples) for implementing different features of the provided subject matter. Specific examples of components and arrangements are described below to simplify the present disclosure. These are, of course, merely examples and are not intended to be limiting. For example, the formation of a first feature over a second feature in the description that follows may include embodiments in which the first and second features are formed in direct contact, and may also include embodiments in which additional features may be formed between the first and second features, such that the first and second features may not be in direct contact. As used herein, the formation of a first feature on a second feature means the first feature is formed in direct contact with the second feature. In addition, the present disclosure may repeat reference numerals and/or letters in the various examples. This repetition does not in itself dictate a relationship between the various embodiments and/or configurations discussed.

The term “lens” as used herein is used to broadly refer to an optical component. For example, eyeglass/sunglass lenses, vision shields, visors, and the like are included in the term “lens” or “lens for eyewear.” The term “non-corrective” as used herein indicates a lack of optical power as understood for prescription lenses.

Spatially relative terms, such as “beneath,” “underlying,” “underneath,” “below,” “lower,” “above,” “over,” “upper,” “lower,” and the like may be used herein for ease of description to describe one element or feature's relationship to another element(s) or feature(s) as illustrated in the figures. The spatially relative terms are intended to encompass different orientations of the device in use or operation in addition to the orientation depicted in the figures. The device may be otherwise oriented (rotated 90 degrees or at other orientations) and the spatially relative descriptors used herein may likewise be interpreted accordingly.

It is noted that references in the specification to “one embodiment,” “an embodiment,” “an example embodiment,” “exemplary,” etc., indicate that the embodiment described may include a particular feature, structure, or characteristic, but every embodiment may not necessarily include the particular feature, structure, or characteristic. Moreover, such phrases do not necessarily refer to the same embodiment. Further, when a particular feature, structure or characteristic is described in connection with an embodiment, it would be within the knowledge of one skilled in the art to effect such feature, structure or characteristic in connection with other embodiments whether or not explicitly described.

It is to be understood that the phraseology or terminology herein is for the purpose of description and not of limitation, such that the terminology or phraseology of the present specification is to be interpreted by those skilled in relevant art(s) in light of the teachings herein.

In some aspects, the terms “about” and “substantially” can indicate a value of a given quantity that varies within 5% of the value (e.g., +1%, +2%, +3%, +4%, or +5% of the value).

As used herein, the term “between a first value and a second value,” as used for example in “a contact area is between about 70 mm² and about 100 mm²,” means that the contact area range is from about 70 mm² to about 100 mm², where end points of about 70 mm² and about 100 mm² are both included in the wavelength range.

The terms “wearer,” “user,” and the like as used herein may refer to a median user in general, a median user according to a demographic, or a user having physical dimensions conforming to a standard or a well-known database of human measurements. For example, an eyewear wearer may be one having physical dimensions that conform to European Standards (EN), American National Standards Institute (ANSI), or anthropometric surveys, among others.

The eyewear described herein can be any type, including general-purpose eyewear, special-purpose eyewear, sunglasses, driving glasses, sporting glasses, indoor eyewear, outdoor eyewear, vision-correcting eyewear, prescription and non-prescription eyeglasses, color vision deficiency eyewear, contrast-enhancing eyewear, chroma-enhancing eyewear, color-enhancing eyewear, color-altering eyewear, gaming eyewear, eyewear designed for another purpose, or eyewear designed for a combination of purposes.

Additionally, although particular embodiments may be disclosed or shown in the context of particular types of eyewear, such as unitary lens eyeglasses, dual lens eyeglasses, eyeglasses having partial, full, or no orbitals, goggles, sunglasses, and the like, it is to be appreciated that embodiments of the present invention may be used in any type of headworn support.

As used herein, the term “disposed,” as used for example in “a first layer is disposed over a second layer,” means that the first layer is either directly placed against the second layer's surface, or that the first layer is indirectly placed over the second layer's surface with at least a third layer in between.

As used herein, the term “coupled,” as used for example in “a first layer is coupled to a second layer” means that the first layer is disposed over the second layer (as “disposed” is defined above), or that the first layer is integrated into the second layer.

It is to be understood that the frame of reference (e.g., the axes and planes) described herein are discussed in connection within standard contexts with a user's head in an upright vertical position, For example, an anatomical superior-inferior axis is generally referred to in connection with a vertical axis, the anatomical medio-lateral axis is generally referred to in connection with a horizontal plane. This can be measured, for example, on a standard headform such as, but not limited to, an Alderson headform, an EN168 headform, a CSA Z262.2-14 headform, an ISO headform (e.g., ISO medium symmetry headform), or any other standard headform. However, it is also understood that the frame of reference described herein may be shifted in other contexts.

Despite the many advances of eyewear, there is a continuing need for an eyewear having excellent retention during low or high movement activities, while at the same time allowing maximum comfort to the wearer. Described herein is an ear stem for an eyewear having enhanced retention and comfort for the wearer.

In some aspects, an ear stem for an eyewear disclosed herein includes at least a flexible stem portion. The flexible stem portion can flex in tensional headstrap-like engagement against the head of the wearer, without requiring the head to be fully encircled. The ear stem described herein provides the advantage of accommodating different head sizes for a secure fit during high movement sport activities while maintaining comfort for the wearer.

In some aspects, a contact surface of the flexible stem portion with the head of the wearer may vary along the length of the flexible stem portion. For example, the contact surface of the flexible stem portion may be greater at a distal end of the stem body compared to the proximal end. This provides additional frictional retention on the head of the wearer in high movement activities.

In some aspects, one or more metrics and properties of the ear stem are configured to improve retention on a head of the wearer and comfort to the wearer. For example, a contact area of the ear stem with the head of the wearer when worn by the wearer is greater than about 70 mm² and the average pressure is less than 7 kPA. The average pressure may be measured using at least one pressure sensitive area on an ISO headform.

In some aspects, a product of an average pressure and a displacement of the ear stem is less than 25 N/mm when the headform is subjected to an acceleration of 17 g and the average pressure is measured by at least one pressure sensitive area on the headform and when the eyewear is positioned on the headform. Thus, the ear stem provides enhanced retention on the head of the wearer while maintaining comfort (i.e., reducing pressure on the head of the wearer).

In some aspects, the ear stem may be coupled to an eyewear. In some aspects, the ear stem described herein may be included in an ear stem kit. The ear stem may be selectively attached to a frame of an eyewear by the user.

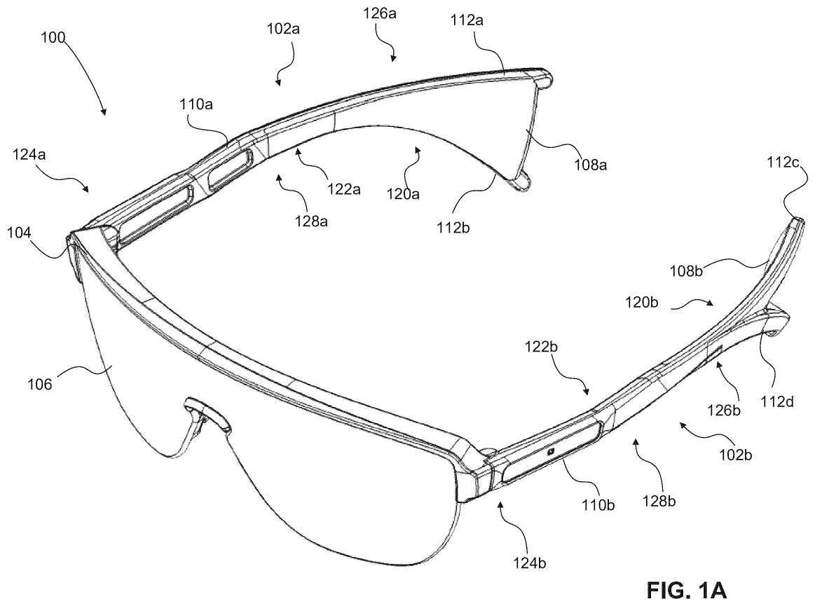

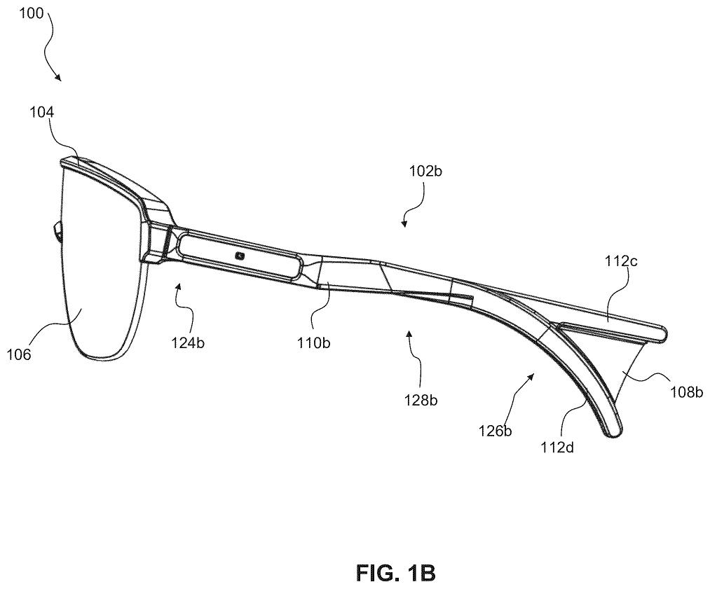

FIG. 1A illustrates a perspective view of an eyewear 100 configured to provide head retention and pressure performance enhancement, according to some aspects. FIG. 1B illustrates a side view of eyewear 100. Eyewear 100 comprises a frame 104, a first ear stem 102a and a second ear stem 102b. Frame 104 is configured to hold one or more lenses in the path of a wearer's field of vision. In FIG. 1A, eyewear 100 is shown to include a single lens (unitary lens) wherein a single lens is in front of both eyes of the wearer. However, it is to be understood that eyewear 100 may include more than a single lens 106 (e.g., a dual lens eyewear with one lens in front of each eye of the wearer). Frame 104 is connected to first ear stem 102a and second ear stem 102b. For example, frame 104 may include attachment points for first ear stem 102a and second ear stem 102b. First ear stem 102a and second ear stem 102b supports the eyewear on a head of a wearer. In some aspects, the ear stems are supported directly by the lens, in lieu of the frame. In some aspects, lens 106 can be designed with sufficient structural rigidity to serve as the main structural support of eyewear 100. Further, lens 106 may include attachment points for ear stems 102a, 102b. Examples of frameless eyewear are described in U.S. Pat. Nos. 11,679,033 and 11,526,025, which are both incorporated herein by reference in their entireties.

In some aspects, frame 104 may be configured to hold at least a portion or an entirety of the periphery of lens 106. Frame 104 is shown extending along a top periphery of lens 106 in FIG. 1A; however, it is to be understood that frame 104 may extend along a bottom periphery of lens 106 in combination with or in lieu of the portion which extends along the top periphery of lens 106, may extend along the entirety of periphery of lens 106, or may extend along one or two side peripheries of lens 106.

In some aspects, each of first ear stem 102a and second ear stem 102b comprises a stem body and a flexible stem portion. Second ear stem 102b may be a mirror image of first ear stem 102a. Any description related to first ear stem 102a or second ear stem 102b may also apply to second ear stem 102b and first ear stem 102a, respectively. For example, the properties and characteristics of first ear stem 102a may be also attributable to second ear stem 102b. For example, first ear stem 102a comprises a stem body 110a and a flexible stem portion 108a. Second ear stem 102b comprises a stem body 110b and a flexible stem portion 108b. Flexible stem portion 108a and flexible stem portion 108b are supported by stem body 110a and stem body 110b, respectively. Flexible stem portion 108a and flexible stem portion 108b are positioned between stem body 110a and stem body 110b and the head of the wearer, respectively, when the eyewear is worn by the wearer.

In some aspects, second ear stem 102b may not be a mirror image of first ear stem 102a. In some aspects, second ear stem 102b or first ear stem 102a can have different properties and characteristics from first ear stem 102a or second ear stem 102b, respectively. For example, first ear stem 102a may not comprise a flexible stem portion or may have a flexible stem portion having properties (e.g., shape, material) different than flexible stem portion 108b.

In some aspects, a proximal end 124a of stem body 110a may be coupled to frame 104 and a proximal end 124b of stem body 110b may be coupled to frame 104. In some aspects, proximal end 124a of stem body 110a may be coupled to lens 106 and proximal end 124b of stem body 110b may be coupled to lens 106.

In some aspects, first stem body 110a may comprise a first prong 112a and a second prong 112b. Second stem body 110b may comprise a third prong 112c and a fourth prong 112d. In some aspects, a distal end portion 126a of first stem body 110a and a distal end portion 126b of second stem body 110b have a wish-bone shape. In some aspects, distal end portion 126a of first stem body 110a may comprise first prong 112a and second prong 112b and distal end portion 126b of second stem body 110b may comprise third prong 112c and fourth prong 112d.

In some aspects, a first end 122a of first flexible stem portion 108a may be coupled to a middle section 128a of first stem body 110a and a first end 122b of second flexible stem portion 108b is coupled to a middle section 128b of second stem body 110b. In some aspects, a second end 120a of first flexible stem portion 108a may be coupled to distal end portion 126a of first stem body 110a and a second end 120b of second flexible stem portion 108b may be coupled to distal end portion 126b of second stem body 110b. Second end 120a of first flexible stem portion 108a may be coupled to first prong 112a and second prong 112b. In some aspects, second end 120a of first flexible stem portion 108a may be coupled to distal ends of first prong 112a and second prong 112b. Second end 120b of second flexible stem portion 108b may be coupled to third prong 112c and fourth prong 112d. In some aspects, second end 120a of first flexible stem portion 108a may be coupled to first prong 112a and to second prong 112b such that first flexible stem portion 108a is suspended between first prong 112a and second prong 112b. In some aspects, second end 120b of second flexible stem portion 108b is coupled to third prong 112c and to fourth prong 112d such that flexible stem portion 108b is suspended between third prong 112c and fourth prong 112d. For example, at least a portion of first flexible stem portion 108a and second flexible stem portion 108b are separated from first stem body 110a and second stem body 110b, respectively.

In some aspects, lenses and frames of many other shapes and configurations may be used for eyewear 100. It should be noted that eyewear 100 shown in FIGS. 1A-1B is not drawn to scale but is drawn to more easily illustrate certain aspects of eyewear 100.

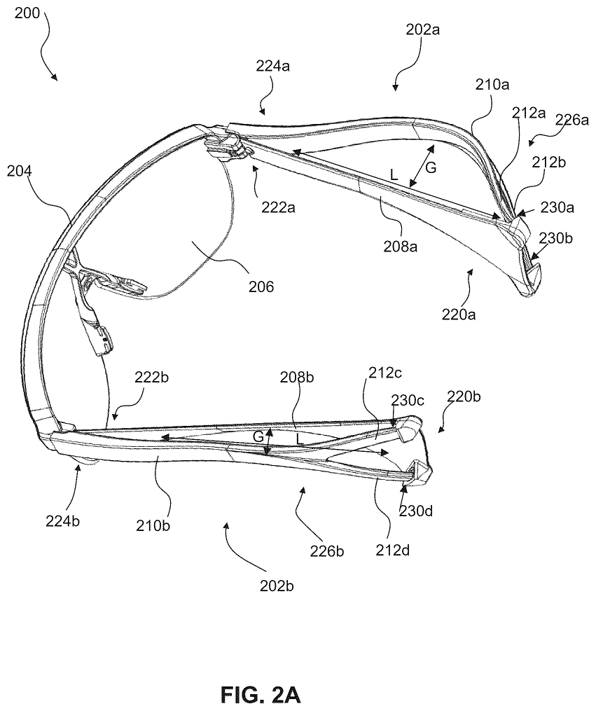

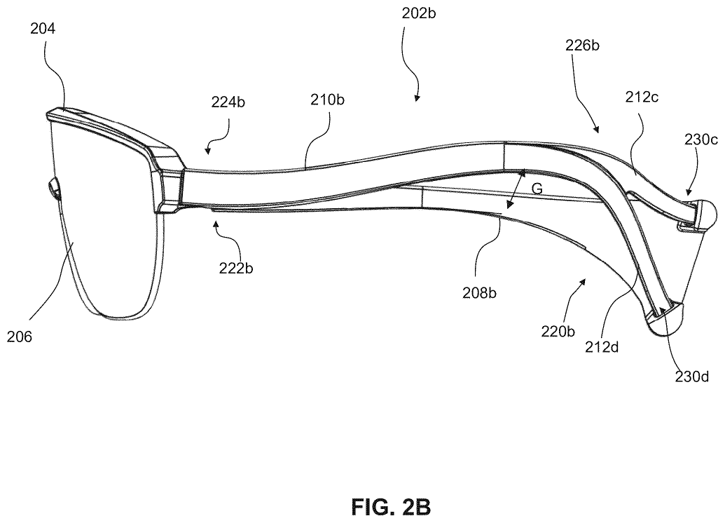

FIG. 2A illustrates a perspective view of an eyewear 200 configured to provide head retention and pressure performance enhancement, according to some aspects. FIG. 2B illustrates a side view of eyewear 200.

Eyewear 200 comprises a frame 204, a first ear stem 202a, and a second ear stem 202b. Frame 204 is configured to hold one or more lenses in the path of a wearer's field of vision. In FIG. 2A, eyewear 200 is shown to include a single lens 206 (unitary lens) wherein a single lens is in front of both eyes of the wearer. However, it is to be understood that eyewear 200 may include more than a single lens (e.g., a dual lens eyewear with one lens in front of each eye of the wearer). Frame 204 is connected to first ear stem 202a and second ear stem 202b. For example, frame 204 may include attachment points for first ear stem 202a and second ear stem 202b. First ear stem 202a and second ear stem 202b support the eyewear on a head of a wearer. In some aspects, the ear stems are supported directly by the lens, in lieu of the frame. In some aspects, lens 206 can be designed with sufficient structural rigidity to serve as the main structural support of eyewear 200. Further, lens 206 may include attachment points for ear stems 202a, 202b. Examples of frameless eyewear are described in U.S. Pat. Nos. 11,679,033 and 11,526,025, which are both incorporated herein by reference in their entireties.

In some aspects, frame 204 can be configured to hold at least a portion or an entirety of the periphery of lens 206. Frame 204 is shown extending along a top periphery of lens 206 in FIG. 2A; however, it is to be understood that frame 204 may extend along a bottom periphery of lens 206 in combination with or in lieu of the portion which extends along the top periphery of lens 206, may extend along the entirety of periphery of lens 206, or may extend along one or two side peripheries of lens 206.

In some aspects, each ear steam of first ear stem 202a and second ear stem 202b comprises a stem body and a flexible stem portion. Second ear stem 202b may be a mirror image of first ear stem 202a. Any description related to first ear stem 202a or second ear stem 202b may also apply to second ear stem 202b and first ear stem 202a, respectively. For example, the properties and characteristics of first ear stem 202a may also be attributable to second ear stem 202b. For example, first ear stem 202a comprises a stem body 210a and a flexible stem portion 208a. Second ear stem 202b comprises a stem body 210b and a flexible stem portion 208b. Flexible stem portion 208a and flexible stem portion 208b are supported by stem body 210a and stem body 210b, respectively. Flexible stem portion 208a and flexible stem portion 208b are positioned between stem body 210a and stem body 210b, respectively and the head of the wearer when eyewear 200 is worn by the wearer.

In some aspects, second ear stem 202b may not be a mirror image of first ear stem 202a. In some aspects, second ear stem 202b or first ear stem 202a can have different properties and characteristics from first ear stem 202a or second ear stem 202b, respectively. For example, first ear stem 202a may not comprise a flexible stem portion or may have a flexible stem portion having properties (e.g., shape, material) different from flexible stem portion 208b.

In some aspects, first stem body 210a may comprise a first prong 212a and a second prong 212b. Second stem body 210b comprises a third prong 212c and a fourth prong 212d. In some aspects, a distal end portion 226a of first stem body 210a and a distal end portion 226b of second stem body 210b have a wish-bone shape. In some aspects, distal end portion 226a of first stem body 210a comprises first prong 212a and second prong 212b and distal end portion 226b of second stem body 210b comprises third prong 212c and fourth prong 212d. In some aspects, third prong 212c is a mirror image of first prong 212a, and fourth prong 212d is a mirror image of second prong 212b.

In some aspects, a first end 222a of flexible stem portion 208a may be coupled to a proximal end 224a of stem body 210a and a first end 222b of flexible stem portion 208b may be coupled to a proximal end 224b of stem body 210b. In some aspects, the first end 222a of first flexible stem portion 208a and the first end 222b of flexible stem portion 208b may be coupled to frame 204. In some aspects, first end 222a of flexible stem portion 208a and first end 222b of flexible stem portion 208b may be coupled to lens 206.

In some aspects, proximal end 224a of stem body 210a may be coupled to frame 204 and proximal end 224b of stem body 210b may be coupled to frame 204. In some aspects, proximal end 224a of stem body 210a may be coupled to lens 206 and proximal end 224b of stem body 210b may be coupled to lens 206.

In some aspects, a second end 220a of first flexible stem portion 208a may be coupled to a distal end 226a of first stem body 210a and a second end 220b of second flexible stem portion 208b may be coupled to a distal end 226b of second stem body 210b. Second end 220a of first flexible stem portion 208a may be coupled to first prong 212a and second prong 212b. In some aspects, second end 220b of second flexible stem portion 208b may be coupled to third prong 212c and to fourth prong 212d. In some aspects, second end 220a of first flexible stem portion 208a may be coupled to a distal end 230a of first prong 212a and to a distal end 230b of second prong 212b. Second end 220b of second flexible stem portion 208b may be coupled to a distal end 230c of third prong 212c and to a distal end 230d of fourth prong 212d.

In some aspects, first flexible stem portion 208a may be suspended between proximal end 224a and distal end 226b of first stem body 210a. Second flexible stem portion 208b may be suspended between proximal end 224b and distal end 226b of second stem body 210b. For example, at least a portion of first flexible stem portion 208a and second flexible stem portion 208b are separated from first stem body 210a and second stem body 210b, respectively.

In some aspects, proximal end 224a of stem body 210a and distal end 226a of stem body 210a are separated by a length L, and flexible stem portion 208a is separated from stem body 210a along length to create a gap G. Similarly, the proximal end 224b of stem body 210b and the distal end 226b of stem body 210b are separated by a length L, and flexible stem portion 208b is separated from stem body 210b along the length to create a gap G.

In some aspects, lenses and frames of many other shapes and configurations may be used for eyewear 200. It should be noted that eyewear 200 shown in FIGS. 2A-2B is not drawn to scale but is drawn to more easily illustrate certain aspects of eyewear 200.

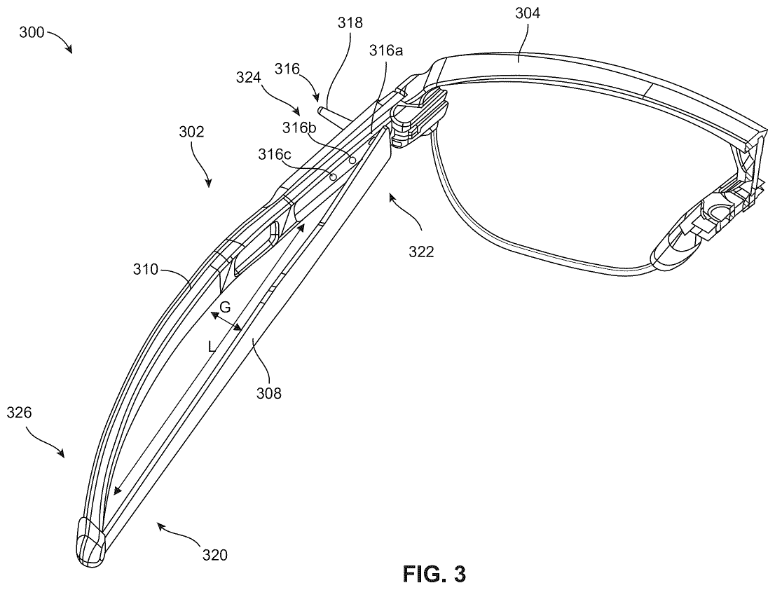

FIG. 3 is a schematic that illustrates an eyewear 300 configured to provide head retention and pressure performance enhancement including tension adjustability features, according to some aspects. For illustrative purposes, only a portion of eyewear 300 is shown in FIG. 3. Eyewear 300 may include two ear stems coupled to a frame 304. For example, eyewear 300 includes ear stem 302. Ear stem 302 may include a stem body 310 and a flexible stem portion 308. In some aspects, a proximal end 322 and a distal end 320 of flexible stem portion 308 may respectively be coupled to a proximal end 324 and a distal end 326 of stem body 310.

In some aspects, the proximal end 324 of stem body 310 and the distal end 326 of stem body 310 are separated by a length L, and flexible stem portion 308 is separated from stem body 310 along the length L to create a gap G.

In some aspects, flexible stem portion 308 may couple to stem body 310 at one anchor of a plurality of anchors 316. The plurality of anchors may be formed on stem body 310 either at proximal end 324 of stem body 310 (as shown in FIG. 3), at distal end 326 of stem body 310, or both at proximal end 324 of stem body 310 and distal end 326 of stem body 310. In some aspects, the plurality of anchors 316 may correspond to a plurality of female sockets, such as openings 316a formed at the proximal end of stem body 310 configured to capture and secure flexible stem portion 308 to stem body 310 at the location of the socket. Flexible stem portion 308 may include a male stud, such as a protrusion 318, configured to couple to a socket (e.g., an opening 316a of the plurality of openings 316a, 316b, 316c). In some aspects, protrusion 318 may be formed on a proximal end of flexible stem portion 308. In some aspects, the wearer may adjust the tension by selecting the opening to which protrusion 318 is coupled. For example, to enable a higher tension fit, the wearer may couple protrusion 318 to the opening closest to proximal end 324 of stem body 310 (e.g., opening 316a in FIG. 3). In order to enable a lower tension, the protrusion 318 may be coupled to the distal opening with respect to proximal end 324 of stem body 310 (e.g., an opening 316c in FIG. 3).

Although FIG. 3 shows one ear stem 302, it is to be understood that eyewear 300 may include another ear stem. In some aspects, the other ear stem may be a mirror image of ear stem 302 having similar tension adjustability features described with reference to ear stem 302 or may have variations such as the tension adjustability features described with reference to ear stem 402.

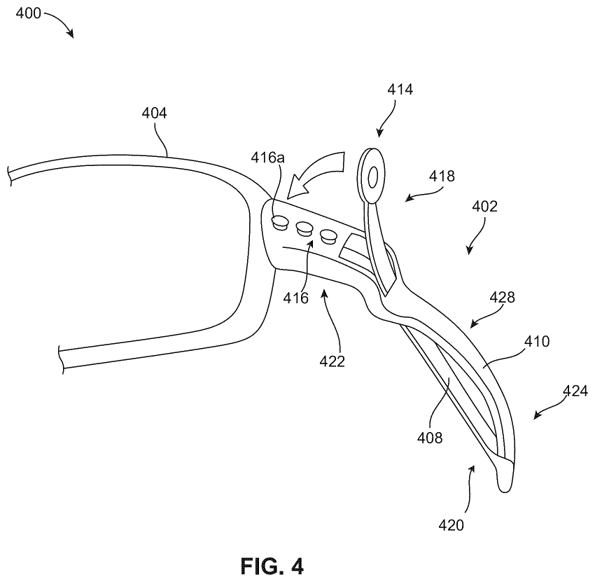

FIG. 4 is a schematic that illustrates an eyewear 400 with pressure and retention adjustment, including tension adjustability features according to some aspects. For illustrative purposes, only a portion of eyewear 400 is shown in FIG. 4. Eyewear 400 may include two ear stems coupled to a frame 404. For example, eyewear 400 may include ear stem 402. Ear stem 402 may include a stem body 410 and a flexible stem portion 408. In some aspects, a proximal end 418 and a distal end 420 of flexible stem portion 408 may respectively be coupled to a proximal end 422 and a distal end 424 of stem body 410. In other aspects, proximal end or distal end of flexible stem portion 408 may couple to a middle section 428 of stem body 410.

In some aspects, flexible stem portion 408 may be selectively adjustable by the wearer. The retention and pressure exerted by the ear stem may be adjusted by the wearer. In some aspects, the flexible stem portion 408 couples to the proximal end 418 of stem body 410 or the distal end 420 of the stem body 410 at an anchor, such as a stud 416a of a plurality of anchors 416 formed on stem body 410. The plurality of anchors 416 may correspond to tension setting anchors to vary the tension of the flexible stem portion 408 on the head of the wearer. Such adjustment can enable higher tension fit for high movement activities (e.g., a sport setting) or a lower comfort tension fit for low movement activities (e.g., casual setting).

In some aspects, plurality of anchors 416 may be male studs 416a such as a protrusion and formed on the proximal end 422 of stem body 410. Flexible stem portion 408 may include a female socket, e.g., an opening 414 configured to receive and secure to one of the studs 416a depending on the desired setting of the wearer (e.g., the stud may be snap fit into the socket). The plurality of anchors 416 may be formed in either side of stem body 410. For example, for ease of access, the plurality of anchors 416 may face opposite to the head of the wearer as illustrated in FIG. 4.

Although FIG. 4 shows one ear stem 402, it is to be understood that eyewear 400 may include another ear stem. In some aspects, the another ear stem may be a mirror image of ear stem 402 having similar tension adjustability features described with reference to ear stem 402 or may have variations such as the tension adjustability features described with reference to ear stem 302.

In some aspects, the tension adjustability features described with reference to eyewear 300 and eyewear 400 may be incorporated in other ear stem constructions/configurations, such as, without limitation, eyewear 200 or eyewear 100.

In some aspects, the stem body of the ear stem described herein (e.g., stem body 110a, stem body 110b, stem body 210a. stem body 210b, stem body 310, stem body 410, and the like) is formed from a rigid material (e.g., nylon, acetate, metal, carbon fiber, wood). In some aspects, the rigid material may include one or more materials having varying degree of elasticity. In some aspects, the stem body of ear stem may be formed of a more rigid material compared to the flexible stem portion.

In some aspects, the flexible stem portion (e.g., flexible stem portion 108a, flexible stem portion 108b, flexible stem portion 208a, flexible stem portion 208b, flexible stem portion 308, flexible stem portion 408, and the like) may be formed from a material having less rigidity compared to the stem body, for example, using an elastomeric material. For example, the flexible stem portion may be formed from a thermoplastic elastomer material. The thermoplastic elastomer material may be thermoplastic polyurethane (TPU).

### Example Retention and Performance Measurements

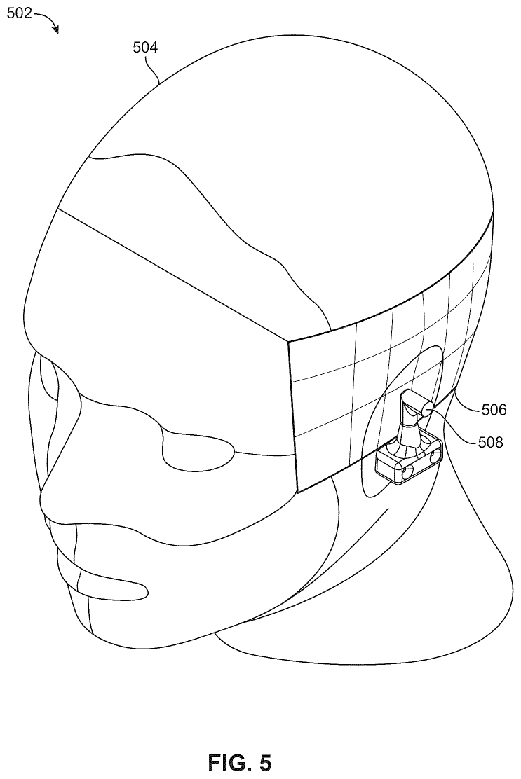

FIG. 5 illustrates an example pressure measurement environment 502, according to an example embodiment. Pressure measurement environment 502 may be used to determine an average pressure exerted by an ear stem of an eyewear on a head of a wearer. Pressure measurement environment 502 comprises a mounting stage that may correspond to an ISO headform 504. ISO headform 504 may include a plurality of pressure sensitive areas. In one example, ISO headform 504 may include a first area 506. ISO headform 504 may also include a second area (not shown in FIG. 5) to measure the pressure exerted by the second ear stem of the eyewear.

During pressure measurements, an eyewear including without limitation any of eyewear described above with reference to the figures is positioned on ISO headform 504 in the as-worn position and the pressure exerted by the ear stem and recorded by first area 506 is obtained. In some aspects, the eyewear is positioned on ISO headform using a first protrusion 508 and a second protrusion (not shown in FIG. 5) extending from the headform to replicate an ear rest position for supporting the ear stems of the eyewear on the headform. In some aspects, the average pressure across the pressure sensitive area is recorded. In some aspects, the pressure at specific points within the pressure sensitive area is recorded. Additionally or alternatively, the maximum pressure exerted by the ear stem on the pressure sensitive area may be obtained.

In some aspects, the average pressure exerted by an ear stem in accordance with the present disclosure is less than about 7 kPa, less than about 5.5 kPa, less than about 5 kPa, less than about 4.5 kPa, less than about 4 kPa, less than about 3.5 kPa, or less than about 3 kPa. In some aspects, the average pressure is between about 2 kPa and about 6 kPa, between 2 kPa and about 5.5 kPa, or between about 3 kPa and about 5 kPa. Eyewear providing such average pressure may include, without limitation, eyewear having the ear stem configurations of eyewear 100, eyewear 200, eyewear 300, or eyewear 400.

In some aspects, a maximum pressure for ear stems disclosed herein may be measured. The maximum pressure measured by at least one pressure sensitive area on the ISO headform is less than about 12 kPa, less than about 10 kPa, between about 5 kPa and about 12 kPa, or between about 5 kPa and about 10 kPa. Eyewear providing such average pressure may include, without limitation, eyewear having the ear stem configurations of eyewear 100, eyewear 200, eyewear 300, or eyewear 400.

In some aspects, a contact area of the ear stem with the head of the wearer is at least about 70 mm², at least about 75 mm², at least about 80 mm², at least about 85 mm², at least about 90 mm², at least about 95 mm², or at least about 100 mm². In some aspects, the contact area is between about 70 mm² and about 100 mm², between about 75 mm² and about 95 mm², between about 80 mm² and about 90 mm². In some aspects, in which the ear stem has a flexible stem portion (such as described above with reference to FIGS. 1A, 1B, 2A, 2B. 3, and 4), the contact area may correspond to the contact area of the flexible stem portion with the head of the wearer. In some aspects, the contact area may be measured on an EN headform or an ISO headform.

In some aspects, a contact area of the ear stem with the head of the wearer is at least 70 mm² and the average pressure is less than or equal to 7 kPa. In some aspects, in which the ear stem has a flexible stem portion (such as described above with reference to FIGS. 1A, 1B, 2A, 2B, 3, and 4), the contact area may correspond to the contact area of the flexible stem portion with the head of the wearer. In some aspects, the contact area is at least 80 mm² and the average pressure is less than or equal to about 5 kPa.

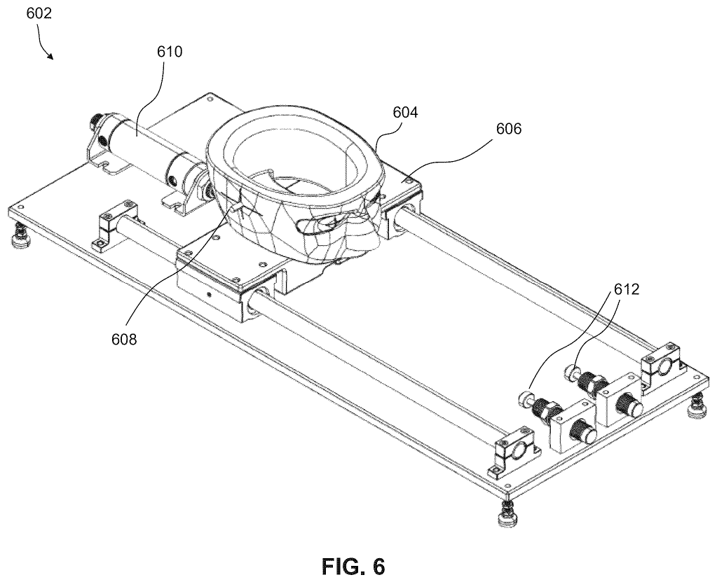

FIG. 6 illustrates an example displacement measurement environment 602, according to an example aspect. Displacement measurement environment 602 may be used to determine the retention properties of an eyewear. Displacement measurement environment 602 comprises a mounting stage that may correspond to a EN headform 604. EN headform 604 may be mounted vertically on a stage 606, or at any other angle to simulate different types of activities. Stage 606 may be a linear stage that may be accelerated at a high speed. In some aspects, a propulsion mechanism such as an air cylinder 610 may be used to propel the linear stage forward until it hits one or more stops 612. During displacement measurements, an eyewear is positioned on headform 604 in the as-worn position. In some aspects, the eyewear is positioned on EN headform 604 using a first protrusion 608 and a second protrusion (not shown in FIG. 6) of EN headform 604 extending from the EN headform 604 to replicate an ear rest position for supporting the ear stems of the eyewear on the EN headform 604. Then, EN headform 604 is propelled forward and abruptly stopped at the end of the stage. A difference between the position of the eyewear relative to EN headform 604 before the movement and the position of the eyewear relative to EN headform 604 after the stop may be measured to determine the displacement measurement. The EN headform 604 may be propelled forward at a plurality of accelerations and the corresponding displacement determined.

In some aspects, the displacement of a predefined point on the ear stem may be measured. For example, the predefined point may correspond to a contact point immediately above an ear of the wearer, e.g., at a point on the ear stem is aligned above and parallel with arm 608 of EN headform 604. A difference between the position of this predefined point relative to EN headform 604 before the movement and this predefined point relative to EN headform 604 after the stop may be measured to determine the displacement measurement.

In some aspects, the displacement is measured for a linear acceleration of the headform of 14 g and 17 g.

In some aspects, a relative displacement of an eyewear including without limitation any of the eyewear described above as measured using displacement measurement environment 602 is less than or equal to about 14 mm when the headform is subjected to an acceleration of 14 g. In some aspects, the displacement when the headform is subjected to an acceleration of 14 g is less than or equal to about 10 mm, is less than or equal to about 8 mm, is less than or equal to about 7 mm, less than or equal to about 6 mm, less than or equal to about 5 mm, or less than or equal to about 3 mm. In some aspects, the displacement when the headform is subjected to an acceleration of 14 g is between about 2 mm and about 8 mm or between about 3 mm and about 7 mm.

In some aspects, the relative displacement for an acceleration of 17 g is less than or equal to about 5 mm, less than or equal to about 4 mm, less than or equal to about 3 mm, or less than or equal to about 2 mm. In some aspects, the relative displacement when the headform is subjected to an acceleration of 17 g is between about 2 mm and about 5 mm, between about 3 mm and about 5 mm, between about 1 mm and about 3 mm, or between about 1 mm and about 4 mm.

Eyewear providing such relative displacement at an acceleration of 14 g and 17 g may include, without limitation, eyewear having the ear stem configurations of eyewear 100, eyewear 200, eyewear 300, or eyewear 400 described above.

In some aspects, the ear stems and eyewear described herein have lower displacement compared to legacy eyewear, exhibiting higher retention while maintaining or improving the comfort to the wearer. In some aspects, a retention comfort metric may be defined as the product of the displacement times the average pressure. The displacement may be determined as described in relation to FIG. 6. The average pressure is measured as described in relation to FIG. 5.

In some aspects, the displacement may be measured when the headform is subjected to an acceleration of 17 g. The product may be less than or equal to about 25 N/mm, less than or equal to about 20 N/mm, less than or equal to about 15 N/mm, less than or equal to about 10 N/mm, or less than or equal to about 6 N/mm. The product may be between about 5 N/mm and about 25 N/mm, between about 7.5 N/mm and about 20 N/mm, between about 10 N/mm and about 15 N/mm, between about 5 N/mm and about 10 N/mm, between about 15 N/mm and about 20 N/mm, or between about 20 N/mm and about 25 N/mm.

In some aspects, the displacement may be measured when the headform is subjected to an acceleration of 14 g. The product may be less than or equal to about 60 N/mm, less than or equal to about 50 N/mm, less than or equal to about 30 N/mm, less than or equal to about 25 N/mm, or less than or equal to about 20 N/mm. The product may be between about 10 N/mm and about 60 N/mm, between 10 N/mm and 40 N/mm, or between about 15 N/mm and about 20 N/mm.

Table 1 shows measured and determined retention and pressure metrics of various legacy eyewear as compared to eyewear having enhanced retention and comfort as described with respect to aspects of the present disclosure. Eyewear 1-5 are eyewear having aspects of the present disclosure. Eyewear 1, eyewear 2, and eyewear 3 in table 1 have stem retentions features similar to eyewear 100 described above with reference to FIGS. 1A and 1B. Eyewear 4 and eyewear 5 in table 1 have stem retentions features similar to eyewear 200 described above with reference to FIGS. 2A and 2B.

TABLE 1
Measured retention and pressure metrics

| | Contact | Average | Maximum | | | 17 g pressure × | 14 g pressure × |
|---|---|---|---|---|---|---|---|
| | Area | Pressure | Pressure | 17 g | 14 g | displacement | displacement |
| Eyewear | (mm²) | (kPa) | (kPa) | Displacement | Displacement | (N/mm) | (N/mm) |
| Legacy 1 | 58 | 5.61 | 9.86 | 6.24 | 12.69 | 35.01 | 71.16 |
| Legacy 2 | 29 | 8.09 | 12.85 | 4.93 | 16.24 | 39.88 | 131.34 |
| Legacy 3 | 39 | 8.58 | 16.85 | 3.09 | 8.03 | 26.51 | 68.85 |
| Legacy 4 | 68 | 6.50 | 12.62 | 7.06 | 12.70 | 45.89 | 82.55 |
| Eyewear 1 | 78 | 6.41 | 19.19 | 1.19 | 2.89 | 7.63 | 18.52 |
| Eyewear 2 | 78 | 2.52 | 6.92 | 2.30 | 6.90 | 5.80 | 17.39 |
| Eyewear 3 | 97 | 5.48 | 11.99 | 2.31 | 4.99 | 12.67 | 27.35 |
| Eyewear 4 | 68 | 4.03 | 8.59 | 2.63 | 7.33 | 10.60 | 29.54 |
| Eyewear 5 | 87 | 4.17 | 10.49 | 3.64 | 13.55 | 15.18 | 56.50 |

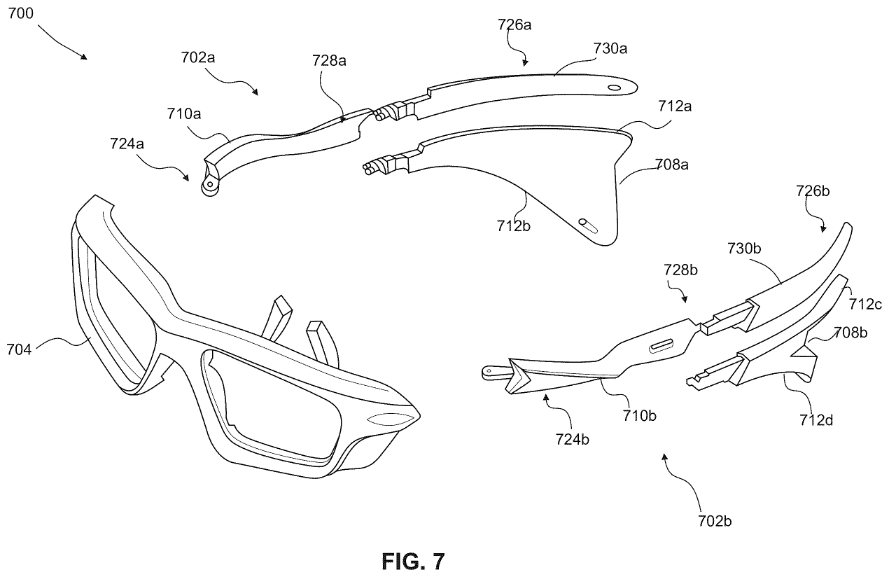

FIG. 7 illustrates a perspective view of disassembled components of an eyewear 700 configured to provide head retention and pressure performance enhancement, according to some aspects. Eyewear 700 comprises a frame 704, a first ear stem 702a and a second ear stem 702b. Frame 704 is configured to hold one or more lenses in the path of a wearer's field of vision. In FIG. 7, eyewear 700 is shown to include two lenses wherein each lens of the two lenses is in front of a respective eye of the wearer. However, it is to be understood that eyewear 700 may include a single lens in front of one or both eyes of the wearer. Eyewear 700 may be, for example and without limitation, spectacles, a goggle, a monocle, a shield, dual lens eyeglasses, eyeglasses having partial, full, or no orbitals, sunglasses, or the like. Frame 704 is connected to first ear stem 702a and second ear stem 702b. For example, frame 704 may include attachment points for first ear stem 702a and second ear stem 702b. First ear stem 702a and second ear stem 702b support the eyewear on a head of a wearer. In some aspects, the ear stems directly support by the lens, in lieu of the frame.

In some aspects, each of first ear stem 702a and second ear stem 702b comprises a stem body and a flexible stem portion. Second ear stem 702b may be a mirror image of first ear stem 702a. Any description related to first ear stem 702a or second ear stem 702b may also apply to second ear stem 702b and first ear stem 702a, respectively. For example, the properties and characteristics of first ear stem 702a may be also attributable to second ear stem 702b. For example, first ear stem 702a comprises a stem body 710a and a flexible stem portion 708a. Second ear stem 702b comprises a stem body 710b and a flexible stem portion 708b. Flexible stem portion 708a and flexible stem portion 708b are supported by stem body 710a and stem body 710b, respectively. Flexible stem portion 708a and flexible stem portion 708b are respectively coupled to stem body 710a and stem body 710b.

In some aspects, second ear stem 702b may not be a mirror image of first ear stem 702a. In some aspects, second ear stem 702b or first ear stem 702a can have different properties and characteristics from first ear stem 702a or second ear stem 702b, respectively. For example, first ear stem 702a may not comprise a flexible stem portion or may have a flexible stem portion having properties (e.g., shape, material) different from flexible stem portion 708b.

In some aspects, one or more components of eyewear 700 may be interchangeable and swappable. In some aspects, components of first ear stem 702a and second ear stem 702b may be modular components that are interchangeable and swappable. For example, the proximal end portions and/or distal end portions and/or middle portions of first ear stem 702a and second ear stem 702b may be discrete parts configured to be replaced with portions offering different aesthetic or functional designs. In some aspects, additional stem portions may be added onto the stem (to extend the stem), for enhancing the features without replacing portions of the existing stem. In some aspects, the components may be interchanged without the need of external tools. The interchangeability can provide the user with a variety of options for use of eyewear 700. For example, the user may attach stem portions other than flexible stem portion 708a and/or flexible stem portion 708b when not participating in sport activities. In some aspects, the user may replace flexible stem portion 708a and flexible stem portion 708b without having to replace other components of eyewear 700. For example, the user may replace flexible stem portion 708a with a first distal stem portion 730a and replace flexible stem portion 708b with a second distal stem portion 730b. First distal stem portion 730a and second distal stem portion 730b may be formed from a material having more rigidity compared to flexible stem portion 708a and flexible stem portion 708b. For example, first distal stem portion 730a and second distal stem portion 730b may be formed from the same material as the stem body 710. The user can obtain different ear stem portions to provide upgraded and/or repaired ear stems, or to provide improvements or enhancements. The user may use different stems or different stem components for different activities and/or for aesthetics. The components may be attached by magnetics and/or mechanical means such as pins, friction fits, and other physical connection techniques, including the combination of magnetic and mechanical connections.

In some aspects, first ear stem 702a may comprise a proximal end portion 724a, a distal end portion 726a, and a middle portion 728a. Second ear stem 702b may comprise a proximal end portion 724b, a distal end portion 726b, and a middle portion 728b. In some aspects, distal end portions 726a,b of the ear stems 702a,b include respectively first distal stem portion 730a and second distal stem portion 730b which are selectively removeable and replaceable with other distal end portions (e.g., flexible stem portions 708a,b). In some aspects, stem body 710a and stem body 710b comprising respective proximal end portions 724a and 724b are removably attached to frame 704 and respective distal end portions 726a and 726b. In some aspects, flexible stem portion 708a may be removably attached to middle portion 728a (replacing first distal stem portion 730a with flexible stem portion 708a), and flexible stem portion 708b may be removably attached to middle section 728b (replacing second distal stem portion 730b with flexible stem portion 708b). Thus, first distal stem portion 730a and second distal stem portion 730b may be disconnected from respective stem bodies 710a and 710b at respective middle portions 728a and 728b, and replaced with flexible stem portion 708a and flexible stem portion 708b connecting to respective middle portions 728a and 728b.

The removeable attachments between proximal end portions 724a,b and frame 704 (in aspects of eyewear featuring interchangeable stem bodies 710a,b), and between proximal end portions 724a,b and distal end portions 726a,b (in aspects of eyewear featuring interchangeable distal end portions, e.g., interchanging portions 730a,b with portions 708a,b) may be any mechanism, including without limitations magnetic attachments and/or by mechanical attachments such as magnets, clips, hooks, or snap fits or other interference fittings, or combinations thereof. It will be appreciated that, although an exhaustive list is not included herein, one skilled in the relevant art will appreciate that various attachment mechanisms may be used, all of which fall within the scope of the present disclosure. Thus, in aspects such as shown in FIG. 7 in which distal end portions 726a and 726b of stems 702a and 702b may be switched between distal stem portions 730a,b and flexible stem portions 708a,b, flexible stem portions 708a and 708b may be attached to stem bodies 710a and 710b (at middle portion 728a and 728b of ear stems 702a and 702b) by any magnetic mechanism, mechanical mechanism, or a combination thereof. For example, flexible stem portions 708a,b and middle portions 728a,b of respective ear stems 702a,b may include one or more magnetic contacts such as magnetic fasteners. The one or more magnetic contacts may include one or more permanent magnets from a ferromagnetic material. Respective magnetic poles of the one or more magnetic contacts may be aligned so that respective one or more magnetic contacts of flexible stem portion 708a and the one or more magnetic contacts of middle portions 728a are mutually attracted to each other, and likewise one or more magnetic contacts of flexible stem portion 708b and the one or more magnetic contacts of middle portions 728b are mutually attracted to each other. The one or more magnetic contacts may be contained within flexible stem portions 708a,b and middle end portions 728a,b. The magnetic contacts may be designed to further include a buckle, snap, slider or other mechanical locking feature to secure the connection between component stem portions, using for example mechanical locking magnetic fasteners supplied by FIDLOCK™.

In some aspects, stem portions such as the flexible stem portions 708a and 708b are add-on features, selectively attached/detached from respective distal end portions 726a and 726b themselves (e.g., not swapping and replacing first distal stem portions 730a and second distal stem portion 730b), for example when further stem structure is desired for enhancing head retention.

In aspects where flexible stem portion 708a and flexible stem portion 708b are connected to the ends of distal end portions 726a and 726b, flexible stem portion 708a and flexible stem portion 708b may be attached using any mechanism, including without limitation magnetic attachments and/or mechanical attachments such as magnets, clips, hooks, or snap fits or other interference fittings, or combinations thereof. For example, flexible stem portion 708a and distal end portion 726a of first ear stem 702a may include one or more magnetic contacts such as magnetic fasteners, mechanical fasteners, or combinations thereof. The one or more magnetic contacts may be contained within flexible stem portion 708a and distal end portion 726a. Similar magnetic clasps or different connection mechanism may be utilized to connect together flexible stem portion 708b and distal end portion 726b. In other examples, flexible stem portion 708a and/or flexible stem portion 708b may include a protrusion and/or depression shaped as a clip, a post, a latch, a housing, a catch, a slot, a clasp, a hollow body, a flange, a hook, or the like, configured to mate with corresponding features on end of distal end portions 726a,b (e.g., in aspects of eyewear featuring stem portions added to stem without interchanging distal end portions 726a and/or 726b). Flexible stem portion 708a and/or flexible stem portion 708b may include a protrusion and/or depression shaped as a clip, a post, a latch, a housing, a catch, a slot, a clasp, a hollow body, a flange, a hook, or the like, configured to mate with corresponding features of middle portion 728a,b (in aspects of eyewear featuring interchangeable distal end portions, e.g., interchanging portions 730a,b with portions 708a,b). In some aspects, flexible stem portion 708a may be added to end of distal end portions 726a,b or middle portion 728a,b via a sliding-locking mechanism or a hook-slot mechanism. In some aspects, flexible stem portion 708a and/or flexible stem portion 708b may be attached to distal end portions 726a,b or middle portion 728a,b using a non-permanent adhesive. In any of the foregoing aspects, it should be understood the connection features may be further enhanced with magnetics to magnetically attract and attach the detachable components of ear stems 702a,b to each other.

In some aspects, flexible stem portion 708a and flexible stem portion 708b may have the structure of the distal end portions of any of the ear stems described herein (e.g., ear stems 102a, 102b, 202a, 202b, 302) for any of the aspects and embodiments described herein, and eyewear with such modular portions may then be imparted with the head retention properties described above in relation to eyewear with ear stems 102a, 102b, 202a, 202b, 302 in FIG. 1A-6.

Any description related to first ear stem 702a may also apply to second ear stem 702b. For example, flexible stem portion 708b may be removably attached to ear stem 702b.

In some aspects, an eyewear kit may include a frame and two or more different types of eyewear stems. For example, the eyewear kit may include a first pair of eyewear stems and a second pair of eyewear stems. The first pair may have enhanced retention and comfort for the wearer such as the eyewear stems disclosed herein (e.g., first ear stem 102a, second ear stem 102b, first ear stem 202a, second ear stem 202b, ear stem 302). The second pair of eyewear stems may be conventional stems.

In some aspects, the eyewear kit may include a frame, one or more stem bodies, and one or more of a plurality of modular portions configured to be attached to the stem body. For example, the eyewear kit may include frame 704, stem body 710a, stem body 710b, flexible stem portion 708a, flexible stem portion 708b, distal stem portion 730a, and distal stem portion 730b.

In some aspects, a portion of the ear stem may be interchangeable. For example, a portion comprising the flexible stem portion may be interchangeable. For example, a portion of the ear stem comprising a distal end and a middle section or the distal end may be interchangeable.

The foregoing disclosure outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

1. An eyewear comprising:
an ear stem, wherein a product of an average pressure and a displacement is less than or equal to about 25 N/mm when a headform is subjected to an acceleration of 17 g and the average pressure is measured by at least one pressure sensitive area on the headform and when the eyewear is positioned on the headform.

2. The eyewear of claim 1, further comprising:
a frame, wherein the frame is connected to the ear stem for supporting the eyewear on a head of a wearer.

3. The eyewear of claim 1, further comprising:
a second ear stem, wherein:
the ear stem is a first ear stem; and
at least one ear stem of the first ear stem or the second ear stem comprises:
a stem body; and
a flexible stem portion supported by the stem body.

4. The eyewear of claim 3, wherein:
a first end of the respective stem portion of the at least one ear stem of the first ear stem or the second ear stem is coupled to a proximal end of the stem body or a middle section of the stem body;
a second of the respective stem portion of the at least one ear stem of the first ear stem or the second ear stem is coupled to a distal end of the stem body; and
the stem portion is separated from the stem body at least along a portion of a length between the proximal end of the stem body and the distal end of the stem body to create a gap.

5. The eyewear of claim 4, wherein the contact area of a respective flexible stem portion of the at least one ear stem of the first ear stem or the second ear stem with the head of the wearer when worn by the wearer is at least about 70 mm² and the average pressure measured by at least one pressure sensitive area on the headform is less than or equal to about 7 kPa.

6. The eyewear of claim 2, wherein a maximum pressure as measured by at least the one pressure sensitive area on the headform is less than or equal to about 12 kPa.

7. The eyewear of claim 2, wherein a contact area of the ear stem with the head of the wearer when worn by the wearer is at least about 70 mm² as measured on the headform.

8. The eyewear of claim 2, wherein the product of the average pressure and the displacement is less than or equal to 60 N/mm when the headform is subjected to an acceleration of 14 g.

9. The eyewear of claim 2, wherein the headform is either an EN headform or an ISO headform.

10. An eyewear comprising:
a first ear stem; and
a second ear stem, wherein a contact area of a least one ear stem of the first ear stem or the second ear stem with a head of a wearer when worn by the wearer is at least about 70 mm² and an average pressure measured by at least one pressure sensitive area on an ISO headform when the eyewear is positioned on the ISO headform is less than or equal to 7 kPA.

11. The eyewear of claim 10, wherein the contact area is at least about 80 mm² and the average pressure is less than about 5 kPa.

12. (canceled)

13. The eyewear of claim 10, wherein:
a product of a displacement of the eyewear and the average pressure is less than or equal to about 25 N/mm when the eyewear is positioned on an EN headform and is subjected to an acceleration of 17 g.

14. (canceled)

15. The eyewear of claim 10, wherein the at least one ear stem of the first ear stem or the second ear stem comprises:
a stem body; and
a flexible stem portion supported by the stem body.

16. The eyewear of claim 15, wherein
the flexible stem portion has a first end and a second end;
the stem body has a proximal end and a distal end;
the first end of the flexible stem portion is coupled to the proximal end of the stem body;
the second end of the flexible stem is coupled to the distal end of the stem body;
the proximal end of the stem body and the distal end of the stem body are separated by a length; and
the flexible stem portion is separated from the stem body along the length to create a gap.

17. The eyewear of claim 15, wherein:
a distal end of the stem body comprises a first prong and a second prong positioned in a wish-bone shape; and
the flexible stem portion is suspended between the first prong and the second prong.

18. An eyewear comprising:
a first ear stem; and
a second ear stem, wherein at least an ear stem of the first ear stem or the second ear stem comprises:
a stem body; and
a flexible stem portion supported by the stem body,
a contact area of the flexible stem portion with the head of the wearer when the eyewear is worn by the wearer is at least about 70 mm² as measured on an EN headform, and
the flexible stem portion is separated from the stem body along a length to create a gap.

19. The eyewear of claim 18, further comprising:
a frame; wherein:
the frame is connected to the first ear stem and the second ear stem for supporting the eyewear on a head of a wearer,

20. The eyewear of claim 18, wherein an average pressure of each ear stem as measured by at least one pressure sensitive area on the EN headform is less than or equal to about 5.5 kPA.

21. The eyewear of claim 20, wherein the average pressure of each ear stem is less than or equal to about 4 kPA.

22. The eyewear of claim 18, wherein the flexible stem portion is formed from a thermoplastic elastomer material.

23. The eyewear of claim 22, wherein the thermoplastic elastomer material is thermoplastic polyurethane (TPU).

24. The eyewear of claim 18, wherein a relative displacement of the eyewear is less than or equal to about 3 mm when the headform is subjected to an acceleration of 17 g, and
wherein the eyewear is positioned on an ISO headform.

25. The eyewear of claim 18, wherein:
the flexible stem portion has a first end and a second end;
the stem body has a proximal end and a distal end;
the first end of the flexible stem portion is coupled to the proximal end of the stem body; and
the second end of the flexible stem is coupled to the distal end of the stem body.

26. The eyewear of claim 25, wherein:
the proximal end of the stem body and the distal end of the stem body are separated by a length; and
the flexible stem portion is separated from the stem body along the length.

27. The eyewear of claim 18, wherein a distal end portion of the stem body comprises a first prong and a second prong positioned in a wish-bone shape.

28. The eyewear of claim 27, wherein the flexible stem portion is coupled to the stem body at a distal end of the first prong, at a distal end of the second prong, and a proximal end of the stem body.

29. The eyewear of claim 27, wherein the flexible stem portion is coupled to the stem body at a middle section of the stem body, at a distal end of the first prong, and at a distal end of the second prong.

30. The eyewear of claim 18, wherein the flexible stem portion is removably coupled to the stem body.

31. (canceled)

32. (canceled)

33. An eyewear, comprising:
a first ear stem; and
a second ear stem, wherein at least one ear stem of the first ear stem or the second ear stem comprises:
a stem body having a proximal end and a distal end, wherein a distal end portion of the stem body comprises a first prong and a second prong; and
a flexible stem portion supported by the stem body, wherein:
the flexible stem portion is positioned between the stem body and the head of the wearer when the eyewear is worn by the wearer, and
the flexible stem portion is coupled to the first prong and the second prong.

34-42. (canceled)

43. The eyewear of claim 33, wherein the stem body is formed from a material that
has more rigidity than the flexible stem portion.

44. The eyewear of claim 33, wherein:
the flexible stem portion has a first end and a second end;
the first end of the flexible stem portion is coupled to a middle section of the stem body; and
the second end of the flexible stem portion is coupled to each of the first prong and the second prong.

45-57. (canceled)

58. The eyewear of claim 33, wherein:
the flexible stem portion has a first end and a second end;
the first end of the flexible stem portion is coupled to at least one of the frame or the proximal end of the stem body;
the second end of the flexible stem portion is coupled to a distal end of each of the first prong and the second prong;
the proximal end of the stem body and the distal end portion of the stem body are separated by a length; and
the flexible stem portion is separated from the stem body along the length.
